(19) United States
(12) Patent Application Publication
(10) Pub. No.: US 2018/0169481 A1
(43) Pub. Date: Jun. 21, 2018

(54) GOLF BALL

(71) Applicant: DUNLOP SPORTS CO. LTD., Kobe-shi (JP)

(72) Inventors: Takahiro SAJIMA, Kobe-shi (JP); Hironori TAKIHARA, Kobe-shi (JP)

(73) Assignee: DUNLOP SPORTS CO. LTD., Kobe-shi (JP)

(21) Appl. No.: 15/785,109

(22) Filed: Oct. 16, 2017

(30) Foreign Application Priority Data
Dec. 19, 2016 (JP) 2016-245452

(51) Int. Cl. A63B 37/00; C08K 13/02; C08L 33/02

(52) U.S. Cl. CPC A63B 37/0087; A63B 37/0074; A63B 37/0088; A63B 37/0065; A63B 37/0033; C08L 2205/03; A63B 37/0064; A63B 37/0067; C08K 13/02; C08L 33/02; A63B 37/0031

(57) ABSTRACT

A golf ball 2 includes a core 4 and a cover 6. A difference (FB₂−FC₂) between a secondary natural frequency FB₂ of the golf ball 2 and a secondary natural frequency FC₂ of the core 4 is greater than 420 Hz and not greater than 760 Hz. Preferably, a sum (FB₂+FC₂) is not greater than 5200 Hz. Preferably, the FC₂ is not less than 1700 Hz and not greater than 2400 Hz. Preferably, the FB₂ is not less than 2250 Hz and not greater than 3050 Hz. Preferably, an amount of compressive deformation Dc of the core 4 is 2.30 to 3.90 mm. Preferably, an amount of compressive deformation Db of the golf ball 2 is 1.80 to 3.30 mm. Preferably, a thickness Tc of the cover 6 is 1.00 to 2.30 mm. Preferably, a Shore D hardness Hc of the cover 6 is 54 to 67.

This application claims priority on Patent Application No. 2016-245452 filed in JAPAN on Dec. 19, 2016. The entire contents of this Japanese Patent Application are hereby incorporated by reference.

### BACKGROUND OF THE INVENTION

### Field of the Invention

The present invention relates to golf balls. Specifically, the present invention relates to golf balls including a core and a cover.

### Description of the Related Art

In golf, golf balls are hit with a wood type club, an iron type club, a hybrid type club (utility), and a putter, etc. Feel at impact upon hitting is of interest to golf players. Generally, golf players desire golf balls having soft feel at impact. JPH11-76461 (U.S. Pat. No. 6,123,629) provides a proposal concerning improvement of feel at impact with a wood type golf club.

In play by beginners, the frequency of a mishit is high. Therefore, beginners are insensitive to feel at impact when hitting a golf ball with a wood type club, an iron type club, or a hybrid type club.

Meanwhile, in putting, even beginners often hit golf balls at the sweet spots of putters. Even beginners are sensitive to feel at impact upon putting. Beginners prefer golf balls with which soft feel at impact is obtained upon putting. JP2000-317016 proposes a golf ball that produces a soft sound and touch when being hit with a putter, due to adjustment of the PGA compression of a core and the hardness of a cover.

In play by beginners, the frequency of a mishit upon putting is also high. With a golf ball having soft feel at impact, due to excessively small reaction upon hitting, it may be difficult to grasp a sense of distance. In particular, in putting in which the distance between a golf ball and a cup is long, a beginner tends to hit the ball with stronger force than necessary, due to fear of insufficient hitting, so that excessive hitting often occurs. Golf balls that have proper feel at impact upon putting and with which a sense of distance is easily adjusted are desired.

Meanwhile, golf players also place importance on spin performance of golf balls. A golf ball to which spin is easily provided when the golf ball is hit has excellent controllability. Generally, a hard golf ball has a high spin rate when being hit with a wedge. The golf ball has excellent controllability upon an approach shot but provides hard feel at impact upon putting. There is still room for improvement of achievement of both desired approach performance and desired feel at impact.

An object of the present invention is to provide a golf ball that allows a sense of distance to be easily adjusted upon putting at a long distance while approach performance of the golf ball is maintained.

### SUMMARY OF THE INVENTION

The present inventors have found that the secondary natural frequencies of a core and a golf ball influence feel at impact, and have proposed a golf ball having excellent feel at impact upon putting in Japanese Patent Application No. 2015-242909, which is a previously filed application. As a result of further research, the present inventors have found that the secondary natural frequencies of a core and a golf ball can also contribute to improvement of a sense of distance upon putting, thereby completing the present invention.

A golf ball according to the present invention includes a core and a cover positioned outside the core. When a secondary natural frequency of the golf ball is FB₂ and a secondary natural frequency of the core is FC₂, a difference (FB₂-FC₂) is greater than 420 Hz and not greater than 760 Hz.

In the golf ball according to the present invention, the difference (FB₂−Fc₂) is greater than 420 Hz and not greater than 760 Hz. The difference (FB₂−FC₂) is great. The feel at impact of the golf ball with a putter is appropriate. According to the golf ball, even a beginner can adjust a sense of distance upon putting. Therefore, even when the distance to a cup is long, occurrence of excessive hitting can be avoided. Furthermore, the golf ball has excellent approach performance.

Preferably, a sum (FB₂+FC₂) of the FB₂ and the FC₂ is not greater than 5200 Hz.

Preferably, the FC₂ is not less than 1700 Hz and not greater than 2400 Hz. Preferably, the FB₂ is not less than 2250 Hz and not greater than 3050 Hz.

Preferably, the core has an amount of compressive deformation Dc of not less than 2.30 mm and not greater than 3.90 mm. Preferably, the golf ball has an amount of compressive deformation Db of not less than 1.80 mm and not greater than 3.30 mm.

Preferably, the cover has a thickness Tc of not less than 1.00 mm and not greater than 2.30 mm. Preferably, the cover has a Shore D hardness Hc of not less than 54 and not greater than 67.

### BRIEF DESCRIPTION OF THE DRAWINGS

FIG. 1 is a cross-sectional view of a golf ball according to an embodiment of the present invention;

FIG. 2 is a conceptual diagram showing a device for measuring a natural frequency of the golf ball in FIG. 1; and

FIG. 3 is a graph plotting secondary natural frequencies FB₂ of golf balls and secondary natural frequencies FC₂ of cores of Examples and Comparative Examples.

### DESCRIPTION OF THE PREFERRED EMBODIMENTS

The following will describe in detail the present invention based on preferred embodiments with appropriate reference to the drawings.

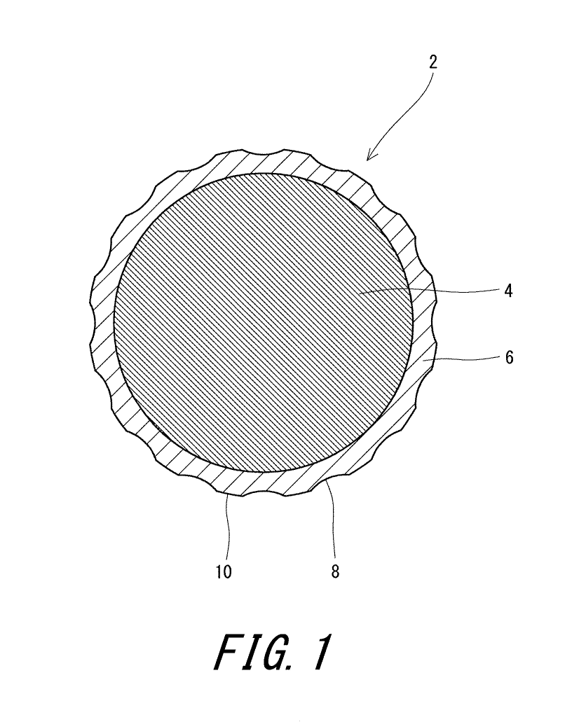

A golf ball 2 shown in FIG. 1 includes a spherical core 4 and a cover 6 positioned outside the core 4. In the present embodiment, the cover 6 is joined directly to the core 4. The golf ball 2 is a so-called two-piece ball. The golf ball 2 has a plurality of dimples 8 on the surface thereof. Of the surface of the golf ball 2, a part other than the dimples 8 is a land 10. The golf ball 2 includes a paint layer and a mark layer on the external side of the cover 6 although these layers are not shown in the drawing.

The golf ball 2 preferably has a diameter of not less than 40 mm but not greater than 45 mm. From the viewpoint of conformity to the rules established by the United States Golf Association (USGA), the diameter is particularly preferably not less than 42.67 mm. In light of suppression of air resistance, the diameter is more preferably not greater than 44 mm and particularly preferably not greater than 42.80 mm. The golf ball 2 preferably has a weight of not less than 40 g but not greater than 50 g. In light of attainment of great inertia, the weight is more preferably not less than 44 g and particularly preferably not less than 45.00 g. From the viewpoint of conformity to the rules established by the USGA, the weight is particularly preferably not greater than 45.93 g.

The core 4 is formed by crosslinking a rubber composition. Examples of preferable base rubbers for use in the rubber composition include polybutadienes, polyisoprenes, styrene-butadiene copolymers, ethylene-propylene-diene copolymers, and natural rubbers. Polybutadienes are preferable. When a polybutadiene and another rubber are used in combination, it is preferred if the polybutadiene is a principal component. Specifically, the proportion of the polybutadiene to the entire base rubber is preferably not less than 50% by weight and particularly preferably not less than 80% by weight. A polybutadiene in which the proportion of cis-1,4 bonds is not less than 80% is particularly preferable.

The rubber composition of the core 4 preferably includes a co-crosslinking agent. Preferable co-crosslinking agents in light of resilience performance of the golf ball 2 are monovalent or bivalent metal salts of an α,β-unsaturated carboxylic acid having 2 to 8 carbon atoms. Examples of preferable co-crosslinking agents include zinc acrylate, magnesium acrylate, zinc methacrylate, and magnesium methacrylate. In light of resilience performance of the golf ball 2, zinc acrylate and zinc methacrylate are particularly preferable.

The rubber composition may include a metal oxide and an α,β-unsaturated carboxylic acid having 2 to 8 carbon atoms. They both react with each other in the rubber composition to obtain a salt. The salt serves as a co-crosslinking agent. Examples of preferable α,β-unsaturated carboxylic acids include acrylic acid and methacrylic acid. Examples of preferable metal oxides include zinc oxide and magnesium oxide.

The amount of the co-crosslinking agent per 100 parts by weight of the base rubber is preferably not less than 10 parts by weight. The golf ball 2 that includes the core 4 in which this amount is not less than 10 parts by weight has excellent resilience performance, and allows a sense of distance to be easily adjusted upon putting. From this viewpoint, this amount is more preferably not less than 15 parts by weight and particularly preferably not less than 20 parts by weight.

The amount of the co-crosslinking agent per 100 parts by weight of the base rubber is preferably not greater than 45 parts by weight. The golf ball 2 that includes the core 4 in which this amount is not greater than 45 parts by weight has excellent approach performance and has soft feel at impact upon putting. From this viewpoint, this amount is more preferably not greater than 40 parts by weight and particularly preferably not greater than 35 parts by weight.

Preferably, the rubber composition of the core 4 includes an organic peroxide. The organic peroxide serves as a crosslinking initiator. The organic peroxide contributes to the resilience performance and the feel at impact of the golf ball 2. Examples of suitable organic peroxides include dicumyl peroxide, 1,1-bis(t-butylperoxy)-3,3,5-trimethylcyclohexane, 2,5-dimethyl-2,5-di(t-butylperoxy)hexane, and di-t-butyl peroxide. An organic peroxide with particularly high versatility is dicumyl peroxide.

The amount of the organic peroxide per 100 parts by weight of the base rubber is preferably not less than 0.1 parts by weight. The golf ball 2 that includes the core 4 in which this amount is not less than 0.1 parts by weight has excellent resilience performance, and allows a sense of distance to be easily adjusted upon putting. From this viewpoint, this amount is more preferably not less than 0.3 parts by weight and particularly preferably not less than 0.5 parts by weight.

The amount of the organic peroxide per 100 parts by weight of the base rubber is preferably not greater than 3.0 parts by weight. The golf ball 2 that includes the core 4 in which this amount is not greater than 3.0 parts by weight has excellent approach performance and has soft feel at impact upon putting. From this viewpoint, this amount is more preferably not greater than 2.5 parts by weight and particularly preferably not greater than 2.0 parts by weight.

The rubber composition of the core 4 includes an organic sulfur compound. Organic sulfur compounds include naphthalenethiol compounds, benzenethiol compounds, and disulfide compounds.

Examples of naphthalenethiol compounds include 1-naphthalenethiol, 2-naphthalenethiol, 4-chloro-1-naphthalenethiol, 4-bromo-1-naphthalenethiol, 1-chloro-2-naphthalenethiol, 1-bromo-2-naphthalenethiol, 1-fluoro-2-naphthalenethiol, 1-cyano-2-naphthalenethiol, and 1-acetyl-2-naphthalenethiol.

Examples of benzenethiol compounds include benzenethiol, 4-chlorobenzenethiol, 3-chlorobenzenethiol, 4-bromobenzenethiol, 3-bromobenzenethiol, 4-fluorobenzenethiol, 4-iodobenzenethiol, 2,5-dichlorobenzenethiol, 3,5-dichlorobenzenethiol, 2,6-dichlorobenzenethiol, 2,5-dibromobenzenethiol, 3,5-dibromobenzenethiol, 2-chloro-5-bromobenzenethiol, 2,4,6-trichlorobenzenethiol, 2,3,4,5,6-pentachlorobenzenethiol, 2,3,4,5,6-pentafluorobenzenethiol, 4-cyanobenzenethiol, 2-cyanobenzenethiol, 4-nitrobenzenethiol, and 2-nitrobenzenethiol.

Examples of disulfide compounds include diphenyl disulfide, bis(4-chlorophenyl)disulfide, bis(3-chlorophenyl)disulfide, bis(4-bromophenyl)disulfide, bis(3-bromophenyl)disulfide, bis(4-fluorophenyl)disulfide, bis(4-iodophenyl)disulfide, bis(4-cyanophenyl)disulfide, bis(2,5-dichlorophenyl)disulfide, bis(3,5-dichlorophenyl)disulfide, bis(2,6-dichlorophenyl)disulfide, bis(2,5-dibromophenyl)disulfide, bis(3,5-dibromophenyl)disulfide, bis(2-chloro-5-bromophenyl)disulfide, bis(2-cyano-5-bromophenyl) disulfide, bis(2,4,6-trichlorophenyl)disulfide, bis(2-cyano-4-chloro-6-bromophenyl)disulfide, bis(2,3,5,6-tetrachlorophenyl)disulfide, bis(2,3,4,5,6-pentachlorophenyl)disulfide, and bis(2,3,4,5,6-pentabromophenyl) disulfide.

In light of resilience performance of the golf ball 2 and a sense of distance upon putting, the amount of the organic sulfur compound per 100 parts by weight of the base rubber is preferably not less than 0.1 parts by weight and particularly preferably not less than 0.2 parts by weight. In light of approach performance and feel at impact, the amount is preferably not greater than 1.5 parts by weight, more preferably not greater than 1.0 part by weight, and particularly preferably not greater than 0.8 parts by weight. Two or more organic sulfur compounds may be used in combination.

The rubber composition of the core 4 may include a filler for the purpose of specific gravity adjustment and the like. Examples of suitable fillers include zinc oxide, barium sulfate, calcium carbonate, and magnesium carbonate. The amount of the filler is determined as appropriate so that the intended specific gravity of the core 4 is accomplished.

The rubber composition may include various additives, such as sulfur, a carboxylic acid, a carboxylate, an anti-aging agent, a coloring agent, a plasticizer, a dispersant, and the like, in an adequate amount. The rubber composition may include crosslinked rubber powder or synthetic resin powder.

The core 4 preferably has a diameter of not less than 38.0 mm. In the golf ball 2 that includes the core 4 having a diameter of not less than 38.0 mm, the cover 6 is thin. In the golf ball 2, the core 4 can contribute to feel at impact upon putting. The feel at impact of the golf ball 2 is soft. From these viewpoints, this diameter is more preferably not less than 38.3 mm and particularly preferably not less than 38.5 mm. In light of durability and approach performance of the golf ball 2, this diameter is preferably not greater than 41.0 mm, more preferably not greater than 40.5 mm, and particularly preferably not greater than 40.0 mm.

The core 4 preferably has an amount of compressive deformation Dc of not less than 2.30 mm. With the core 4 having an amount of compressive deformation Dc of not less than 2.30 mm, the feel at impact upon putting is soft. From this viewpoint, the amount of compressive deformation Dc is more preferably not less than 2.40 mm and particularly preferably not less than 2.50 mm. From the viewpoint of obtaining an appropriate reaction upon putting, the amount of compressive deformation Dc is preferably not greater than 3.90 mm, more preferably not greater than 3.80 mm, and particularly preferably not greater than 3.70 mm.

For measurement of the amount of compressive deformation, a YAMADA type compression tester is used. In the tester, a sphere (the core 4 or the golf ball 2) is placed on a hard plate made of metal. Next, a cylinder made of metal gradually descends toward the sphere. The sphere, squeezed between the bottom face of the cylinder and the hard plate, becomes deformed. A migration distance of the cylinder, starting from the state in which an initial load of 98 N is applied to the sphere up to the state in which a final load of 1274 N is applied thereto, is measured. A moving speed of the cylinder until the initial load is applied is 0.83 mm/s. A moving speed of the cylinder after the initial load is applied until the final load is applied is 1.67 mm/s.

The difference (Hs−Ho) between a Shore C hardness Hs at the surface of the core 4 and a Shore C hardness Ho at the central point of the core 4 is preferably not greater than 30. The core 4 having a difference (Hs−Ho) of not greater than 30 does not excessively suppress the spin performance of the golf ball 2. The core 4 can contribute to the approach performance of the golf ball 2. From this viewpoint, the difference (Hs−Ho) is more preferably not greater than 28 and particularly preferably not greater than 25. In light of flight performance of the golf ball 2, the difference (Hs−Ho) is preferably not less than 12, more preferably not less than 13, and particularly preferably not less than 15.

In light of durability and approach performance, the central hardness Ho is preferably not less than 55, more preferably not less than 58, and particularly preferably not less than 60. In light of feel at impact, the hardness Ho is preferably not greater than 80, more preferably not greater than 75, and particularly preferably not greater than 70.

The hardness Ho is measured with a Shore C type hardness scale mounted to an automated hardness meter (trade name “digi test II” manufactured by Heinrich Bareiss Prüfgerätebau GmbH). The hardness scale is pressed against the central point of the cross-section of a hemisphere obtained by cutting the golf ball 2. The measurement is conducted in the environment of 23° C.

In light of approach performance, the surface hardness Hs is preferably not less than 75, more preferably not less than 78, and particularly preferably not less than 80. In light of durability and feel at impact of the golf ball 2, the hardness Hs is preferably not greater than 95, more preferably not greater than 90, and particularly preferably not greater than 88.

The hardness Hs is measured with a Shore C type hardness scale mounted to an automated hardness meter (trade name “digi test II” manufactured by Heinrich Bareiss PrUfgeratebau GmbH). The hardness scale is pressed against the surface of the core 4. The measurement is conducted in the environment of 23° C.

The core 4 preferably has a weight of not less than 10 g but not greater than 42 g. The temperature for crosslinking the core 4 is equal to or higher than 140° C. but equal to or lower than 180° C. The time period for crosslinking the core 4 is equal to or longer than 10 minutes but equal to or shorter than 60 minutes.

The cover 6 is positioned outside the core 4. The cover 6 is the outermost layer except the mark layer and the paint layer. The cover 6 may be composed of two or more layers. Another layer may be further provided between the cover 6 and the core 4.

The cover 6 is formed from a thermoplastic resin composition. Examples of the base polymer of the resin composition include ionomer resins, thermoplastic polyester elastomers, thermoplastic polyamide elastomers, thermoplastic polyurethane elastomers, thermoplastic polyolefin elastomers, and thermoplastic polystyrene elastomers. Ionomer resins are preferable. Ionomer resins are highly elastic. The cover 6 influences feel at impact and a sense of distance upon putting. The golf ball 2 that includes the cover 6 including an ionomer resin can provide an appropriate reaction upon putting. The cover 6 may be formed from a thermosetting resin composition.

An ionomer resin and another resin may be used in combination. In this case, in light of feel at impact and a sense of distance upon putting, the ionomer resin is included as the principal component of the base polymer. The proportion of the ionomer resin to the entire base polymer is preferably not less than 50% by weight, more preferably not less than 70% by weight, and particularly preferably not less than 85% by weight.

Examples of preferable ionomer resins include binary copolymers formed with an α-olefin and an α,β-unsaturated carboxylic acid having 3 to 8 carbon atoms. A preferable binary copolymer includes 80% by weight or more but 90% by weight or less of an α-olefin, and 10% by weight or more but 20% by weight or less of an α,β-unsaturated carboxylic acid. Examples of other preferable ionomer resins include ternary copolymers formed with: an α-olefin; an α,β-unsaturated carboxylic acid having 3 to 8 carbon atoms; and an α,β-unsaturated carboxylate ester having 2 to 22 carbon atoms. A preferable ternary copolymer includes 70% by weight or more but 85% by weight or less of an α-olefin, 5% by weight or more but 30% by weight or less of an α,β-unsaturated carboxylic acid, and 1% by weight or more but 25% by weight or less of an α,β-unsaturated carboxylate ester. For the binary copolymer and the ternary copolymer, preferable α-olefins are ethylene and propylene, while preferable α,β-unsaturated carboxylic acids are acrylic acid and methacrylic acid. A particularly preferable ionomer resin is a copolymer formed with ethylene and acrylic acid. Another particularly preferable ionomer resin is a copolymer formed with ethylene and methacrylic acid.

In the binary copolymer and the ternary copolymer, some of the carboxyl groups are neutralized with metal ions. Examples of metal ions for use in neutralization include sodium ion, potassium ion, lithium ion, zinc ion, calcium ion, magnesium ion, aluminum ion, and neodymium ion. The neutralization may be carried out with two or more types of metal ions. Particularly suitable metal ions in light of resilience performance and durability of the golf ball 2 are sodium ion, zinc ion, lithium ion, and magnesium ion.

Specific examples of ionomer resins include trade names “Himilan 1555”, “Himilan 1557”, “Himilan 1605”, “Himilan 1706”, “Himilan 1707”, “Himilan 1856”, “Himilan 1855”, “Himilan AM7311”, “Himilan AM7315”, “Himilan AM7317”, “Himilan AM7329”, and “Himilan AM7337”, manufactured by Du Pont-MITSUI POLYCHEMICALS Co., Ltd.; trade names “Surlyn 6120”, “Surlyn 6910”, “Surlyn 7930”, “Surlyn 7940”, “Surlyn 8140”, “Surlyn 8150”, “Surlyn 8940”, “Surlyn 8945”, “Surlyn 9120”, “Surlyn 9150”, “Surlyn 9910”, “Surlyn 9945”, “Surlyn AD8546”, “HPF1000”, and “HPF2000”, manufactured by E.I. du Pont de Nemours and Company; and trade names “IOTEK 7010”, “IOTEK 7030”, “IOTEK 7510”, “IOTEK 7520”, “IOTEK 8000”, and “IOTEK 8030”, manufactured by ExxonMobil Chemical Corporation. Two or more ionomer resins may be used in combination.

The resin composition of the cover 6 may include a styrene block-containing thermoplastic elastomer. The styrene block-containing thermoplastic elastomer includes a polystyrene block as a hard segment, and a soft segment. A typical soft segment is a diene block. Examples of compounds for the diene block include butadiene, isoprene, 1,3-pentadiene, and 2,3-dimethyl-1,3-butadiene. Butadiene and isoprene are preferable. Two or more compounds may be used in combination.

Examples of styrene block-containing thermoplastic elastomers include styrene-butadiene-styrene block copolymers (SBS), styrene-isoprene-styrene block copolymers (SIS), styrene-isoprene-butadiene-styrene block copolymers (SIBS), hydrogenated SBS, hydrogenated SIS, and hydrogenated SIBS. Examples of hydrogenated SBS include styrene-ethylene-butylene-styrene block copolymers (SEBS). Examples of hydrogenated SIS include styrene-ethylene-propylene-styrene block copolymers (SEPS). Examples of hydrogenated SIBS include styrene-ethylene-ethylene-propylene-styrene block copolymers (SEEPS).

In light of resilience performance of the golf ball 2, the content of the styrene component in the styrene block-containing thermoplastic elastomer is preferably not less than 10% by weight, more preferably not less than 12% by weight, and particularly preferably not less than 15% by weight. In light of feel at impact of the golf ball 2, the content is preferably not greater than 50% by weight, more preferably not greater than 47% by weight, and particularly preferably not greater than 45% by weight.

In the present invention, styrene block-containing thermoplastic elastomers include an alloy of an olefin and one or more members selected from the group consisting of SBS, SIS, SIBS, SEBS, SEPS, and SEEPS. The olefin component in the alloy is presumed to contribute to improvement of compatibility with another base polymer. The alloy can contribute to the resilience performance of the golf ball 2. An olefin having 2 to 10 carbon atoms is preferable. Examples of suitable olefins include ethylene, propylene, butene, and pentene. Ethylene and propylene are particularly preferable.

Specific examples of polymer alloys include trade names “RABALON T3221C”, “RABALON T3339C”, “RABALON SJ4400N”, “RABALON SJ5400N”, “RABALON SJ6400N”, “RABALON SJ7400N”, “RABALON SJ8400N”, “RABALON SJ9400N”, and “RABALON SR04”, manufactured by Mitsubishi Chemical Corporation. Other specific examples of styrene block-containing thermoplastic elastomers include trade name “Epofriend A1010” manufactured by Daicel Chemical Industries, Ltd., and trade name “SEPTON HG-252” manufactured by Kuraray Co., Ltd.

In light of feel at impact upon putting, the proportion of the styrene block-containing thermoplastic elastomer to the entire base polymer is preferably not less than 2% by weight, more preferably not less than 4% by weight, and particularly preferably not less than 6% by weight. From the viewpoint that a sense of distance is easily adjusted upon putting, the proportion is preferably not greater than 30% by weight, more preferably not greater than 25% by weight, and particularly preferably not greater than 20% by weight.

The resin composition of the cover 6 may include a coloring agent, a filler, a dispersant, an antioxidant, an ultraviolet absorber, a light stabilizer, a fluorescent material, a fluorescent brightener, and the like in an adequate amount. When the hue of the golf ball 2 is white, a typical coloring agent is titanium dioxide.

The cover 6 preferably has a thickness Tc of not greater than 2.30 mm. The cover 6 having a thickness Tc of not greater than 2.30 mm does not impair soft feel at impact upon putting. From this viewpoint, the thickness Tc is more preferably not greater than 2.20 mm and particularly preferably not greater than 2.10 mm. In light of durability and approach performance of the golf ball 2, the thickness Tc is preferably not less than 1.00 mm, more preferably not less than 1.10 mm, and particularly preferably not less than 1.20 mm. The thickness Tc is measured at a position immediately below the land 10.

From the viewpoint that a sense of distance is easily adjusted upon putting, the cover 6 has a Shore D hardness Hc of preferably not less than 54, more preferably not less than 55, and particularly preferably not less than 56. In light of feel at impact upon putting, the hardness Hc is preferably not greater than 67, more preferably not greater than 66, and particularly preferably not greater than 65.

The hardness Hc of the cover 6 is measured according to the standards of “ASTM-D 2240-68”. The hardness H2 is measured with a Shore D type hardness scale mounted to an automated hardness meter (trade name “digi test II” manufactured by Heinrich Bareiss Prüfgerätebau GmbH). For the measurement, a sheet that is formed by hot press, is formed from the same material as that of the cover 6, and has a thickness of about 2 mm is used. Prior to the measurement, a sheet is kept at 23° C. for two weeks. At the measurement, three sheets are stacked.

The golf ball 2 preferably has an amount of compressive deformation Db of not less than 1.80 mm. With the golf ball 2 having an amount of compressive deformation Db of not less than 1.80 mm, the feel at impact upon putting is soft. From this viewpoint, the amount of compressive deformation Db is more preferably not less than 1.90 mm and particularly preferably not less than 2.00 mm. From the viewpoint that a sense of distance is easily adjusted upon putting, the amount of compressive deformation Db is preferably not greater than 3.30 mm, more preferably not greater than 3.20 mm, and particularly preferably not greater than 3.10 mm.

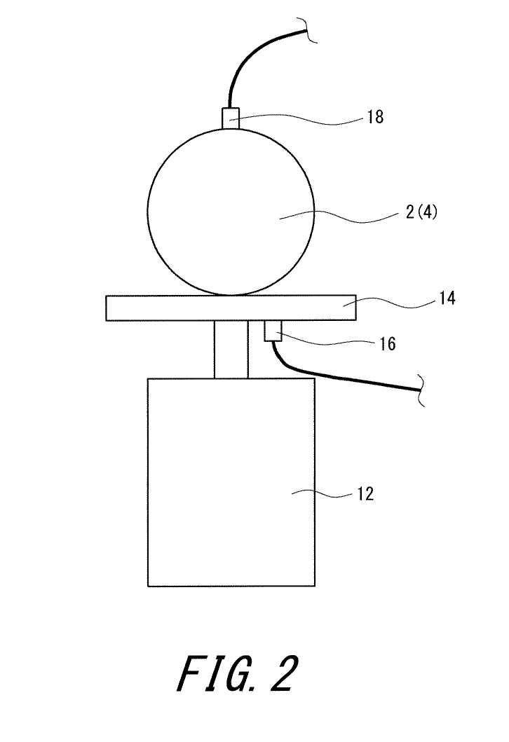

FIG. 2 shows a device for measuring natural frequencies of the core 4 and the golf ball 2. The device includes a vibration exciter 12, a plate 14, a first acceleration pickup 16, and a second acceleration pickup 18. The plate 14 is mounted on the vibration exciter 12. A sphere (the core 4 or the golf ball 2) is placed on the plate 14. The first acceleration pickup 16 is mounted on the plate 14. The second acceleration pickup 18 is mounted on the sphere. Vibration is applied to the sphere by the vibration exciter 12. A signal of acceleration applied to the sphere is outputted from the first acceleration pickup 16. A signal of the acceleration of the sphere is outputted from the second acceleration pickup 18. These signals are inputted into a dynamic signal analyzer. By calculation of the analyzer, a curve is obtained which shows a relationship between frequency and mechanical impedance at the sphere. The frequency at a minimum point of the curve is a natural frequency. The frequency at a minimum point that appears first on the curve is a primary natural frequency. The frequency at a minimum point that appears second on the curve is a secondary natural frequency. The vibration exciter 12 is typically trade name “PET”, manufactured by IMV Corporation. The dynamic signal analyzer is typically trade name “HP-5420A”, manufactured by Yokokawa Hewlett-Packard, Ltd.

As a result of thorough research, the present inventors have found that, when a secondary natural frequency FC₂ (Hz) of the core 4 and a secondary natural frequency FB₂ (Hz) of the golf ball 2 satisfy a predetermined relationship, appropriate feel at impact with which a sense of distance is easily adjusted is obtained upon putting while approach performance is maintained. Particularly, even when the distance to a cup is long, occurrence of excessive hitting can be avoided.

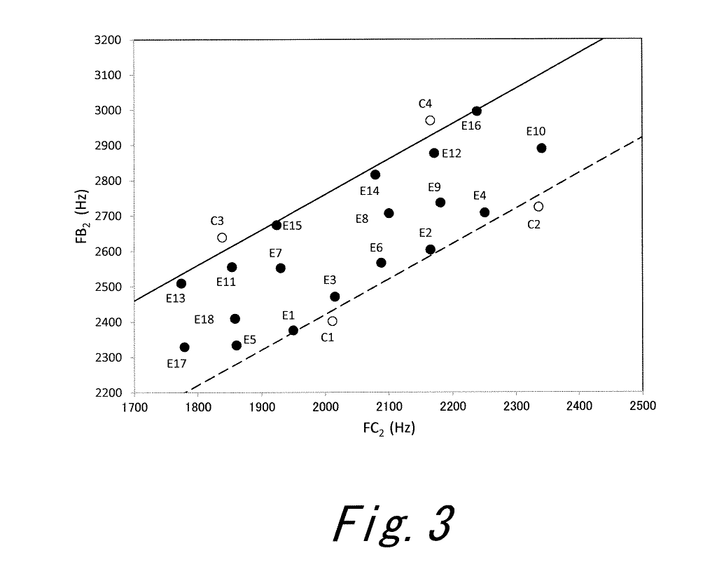

FIG. 3 is a graph showing a relationship between the secondary natural frequency FC₂ of the core 4 and the secondary natural frequency FB₂ of the golf ball 2. In this graph, the horizontal axis indicates the secondary natural frequency FC₂ of the core, and the vertical axis indicates the secondary natural frequency FB₂ of the golf ball. A broken line indicated in this graph is represented by the following (formula 1).

FB₂=FC₂+420 (formula 1)

In the zone above the broken line represented by (formula 1) in this graph, the difference (FB₂−FC₂) between the secondary natural frequency FB₂ of the golf ball 2 and the secondary natural frequency FC₂ of the core 4 exceeds 420 Hz.

According to the finding by the present inventors, the golf ball 2 having a difference (FB₂−FC₂) greater than 420 Hz has appropriate feel at impact upon putting. With the golf ball 2, a golf player who hits the golf ball 2 with a putter obtains a relatively large reaction. Thus, even a beginner who fears insufficient hitting when the distance to a cup is long can hit the golf ball 2 with force smaller than usual, so that occurrence of excessive hitting can be avoided. From the viewpoint that a sense of distance is easily adjusted upon putting, the difference (FB₂−FC₂) is more preferably not less than 440 Hz and further preferably not less than 460 Hz.

A solid line indicated in the graph of FIG. 3 is represented by the following (formula 2).

FB₂=FC₂+760 (formula 2)

In the zone below the solid line represented by (formula 2) in this graph, the difference (FB₂−FC₂) between the secondary natural frequency FB₂ of the golf ball 2 and the secondary natural frequency FC₂ of the core 4 is not greater than 760 Hz. When the golf ball 2 having a difference (FB₂−FC₂) of not greater than 760 Hz is hit with a wedge, the spin rate is high. The golf ball 2 has excellent approach performance. In light of approach performance, the difference (FB₂−FC₂) is more preferably not greater than 740 Hz and further preferably not greater than 720 Hz.

The sum (FB₂+FC₂) of the secondary natural frequency FB₂ of the golf ball 2 and the secondary natural frequency FC₂ of the core 4 is preferably not greater than 5200 Hz. With the golf ball 2 having a sum (FB₂+FC₂) of not greater than 5200 Hz, the feel at impact upon putting is soft. From this viewpoint, the sum (FB₂+FC₂) is more preferably not greater than 5100 Hz and further preferably not greater than 5000 Hz. From the viewpoint that feel at impact with a reaction with which a golf player can grasp a sense of distance is obtained upon putting, the sum (FB₂+FC₂) is preferably not less than 4000 Hz, more preferably not less than 4100 Hz, and further preferably not less than 4200 Hz.

From the viewpoint of obtaining a required difference (FB₂−FC₂), the secondary natural frequency FC₂ of the core 4 is preferably not less than 1700 Hz, more preferably not less than 1750 Hz, and particularly preferably not less than 1800 Hz. The secondary natural frequency FC₂ is preferably not greater than 2400 Hz, more preferably not greater than 2350 Hz, and particularly preferably not greater than 2300 Hz.

From the viewpoint of obtaining a required difference (FB₂−FC₂), the secondary natural frequency FB₂ of the golf ball 2 is preferably not less than 2250 Hz, more preferably not less than 2300 Hz, and particularly preferably not less than 2350 Hz. The secondary natural frequency FB₂ is preferably not greater than 3050 Hz, more preferably not greater than 3000 Hz, and particularly preferably not greater than 2950 Hz.

### EXAMPLES

### Example 1

A rubber composition C was obtained by kneading 100 parts by weight of a high-cis polybutadiene (trade name “BR730”, manufactured by JSR Corporation), 27.8 parts by weight of zinc diacrylate, 5 parts by weight of zinc oxide, an appropriate amount of barium sulfate, 0.5 parts by weight of diphenyl disulfide, and 0.9 parts by weight of dicumyl peroxide. This rubber composition C was placed into a mold including upper and lower mold halves each having a hemispherical cavity, and heated at 160° C. for 20 minutes to obtain a core with a diameter of 40.0 mm. The amount of barium sulfate was adjusted such that the weight of a golf ball was appropriate.

A resin composition c was obtained by kneading 40 parts by weight of an ionomer resin (the aforementioned “Himilan AM7329”), 57 parts by weight of another ionomer resin (the aforementioned “Himilan 1605”), 3 parts by weight of a styrene block-containing thermoplastic elastomer (the aforementioned “RABALON T3221C”), 4 parts by weight of titanium dioxide, and 0.2 parts by weight of a light stabilizer (trade name “JF-90”, manufactured by Johoku Chemical Co., Ltd.) with a twin-screw kneading extruder. The core was placed into a final mold that includes upper and lower mold halves each having a hemispherical cavity. The final mold has a large number of pimples on the cavity face thereof. By injection molding, the melted resin composition c was injected around the core to form a cover with a thickness Tc of 1.35 mm. Dimples having a shape that is the inverted shape of the pimples were formed on the cover.

A clear paint including a two-component curing type polyurethane as a base material was applied to this cover to obtain a golf ball of Example 1 with a diameter of about 42.7 mm and a weight of about 45.6 g. The secondary natural frequency FB₂ of the golf ball and the secondary natural frequency FC₂ of the core that were measured for Example 1 are plotted as E1 in FIG. 3.

### Examples 2 to 18 and Comparative Examples 1 to 4

Golf balls of Examples 2 to 18 and Comparative Examples 1 to 4 were obtained in the same manner as Example 1, except the specifications of the core and the cover were as shown in Tables 4 to 8 below. The specifications of the core are shown in detail in Tables 1 and 2 below. The specifications of the cover are shown in detail in Table 3 below. The secondary natural frequencies FB₂ and FC₂ that were measured for Examples 2 to 18 are plotted as E2 to E18 in FIG. 3, respectively. The secondary natural frequencies FB₂ and FC₂ that were measured for Comparative Examples 1 to 4 are plotted as C1 to C4 in FIG. 3, respectively.

[Approach Performance: Hit with Wedge]

A wedge (trade name “588 RTX 2.0 Tour Satin Wedge”, manufactured by Cleveland Golf Company, Inc., shaft hardness: S, loft angle: 52 degrees) was attached to a swing machine manufactured by Golf Laboratories, Inc. A golf ball was hit under a condition of a head speed of 16 m/s, and the spin rate of the golf ball was measured. The average of values obtained by 12 measurements is shown as AP spin rate (rpm) in Tables 4 to 8 below.

[Putter Evaluation]

On flat lawn, 10 beginners hit golf balls with putters toward a hitting target, and the distances (m) from the hitting point to the points at which the golf balls stopped were measured. The direct distance from the hitting point to the hitting target was 10 m. Each beginner hit three balls, an average was calculated, and a value obtained by subtracting 10 m from the average is shown as putter evaluation (m) in Tables 4 to 8. A positive value means that the golf ball stopped beyond the target (excessive hitting), and a negative value means that the golf ball did not reach the target (insufficient hitting). A golf ball in which the absolute value of the value is small is highly rated.

[Feel at Impact]

On flat lawn, 10 beginners hit golf balls with putters and were asked about feeling. The evaluation was categorized as follows on the basis of the number of golf players who answered, “the feeling was favorable”. The results are shown as feel at impact in Tables 4 to 8 below.

A: 9 and 10

B: 7 and 8

C: 5 and 6

D: 0 to 4

TABLE 1
Composition of Core (parts by weight)

| | A | B | C | D |
|---|---|---|---|---|
| BR730 | 100 | 100 | 100 | 100 |
| Zinc | 26.2 | 27.0 | 27.8 | 28.6 |
| diacrylate | | | | |
| Dicumyl | 0.9 | 0.9 | 0.9 | 0.9 |
| peroxide | | | | |
| Diphenyl | 0.5 | 0.5 | 0.5 | 0.5 |
| disulfide | | | | |
| Zinc oxide | 5 | 5 | 5 | 5 |
| Barium | * | * | * | * |
| sulfate | | | | |

* Appropriate amount

TABLE 2
Composition of Core (parts by weight)

| | E | F | G | H |
|---|---|---|---|---|
| BR730 | 100 | 100 | 100 | 100 |
| Zinc | 29.4 | 30.2 | 31.0 | 31.8 |
| diacrylate | | | | |
| Dicumyl | 0.9 | 0.9 | 0.9 | 0.9 |
| peroxide | | | | |
| Diphenyl | 0.5 | 0.5 | 0.5 | 0.5 |
| disulfide | | | | |
| Zinc oxide | 5 | 5 | 5 | 5 |
| Barium | * | * | * | * |
| sulfate | | | | |

* Appropriate amount

The details of the compounds listed in Tables 1 and 2 are as follows.

BR730: a high-cis polybutadiene manufactured by JSR Corporation (cis-1,4-bond content: 96% by weight, 1,2-vinyl bond content: 1.3% by weight, Mooney viscosity (ML₁₊₄(100° C.)): 55, molecular weight distribution (Mw/Mn): 3)

Zinc diacrylate: trade name “Sanceler SR” manufactured by SANSHIN CHEMICAL INDUSTRY CO., LTD. (a product coated with 10% by weight of stearic acid)

Zinc oxide: trade name “Ginrei R” manufactured by Toho Zinc Co., Ltd.

Barium sulfate: trade name “Barium Sulfate BD” manufactured by Sakai Chemical Industry Co., Ltd.

Dicumyl peroxide: trade name “Percumyl D” manufactured by NOF Corporation

Diphenyl disulfide: bis(pentabromophenyl)disulfide manufactured by Kawaguchi Chemical Industry Co., Ltd.

TABLE 3
Composition of Cover (parts by weight)

| | a | b | c | d | e | f |
|---|---|---|---|---|---|---|
| Himilan | 47 | — | — | — | — | — |
| 1555 | | | | | | |
| Himilan | — | 40 | 40 | 50 | 50 | 50 |
| AM7329 | | | | | | |
| Himilan | 46 | — | — | — | — | — |
| 1557 | | | | | | |
| Himilan | — | 52 | 57 | 47 | 50 | 37.5 |
| 1605 | | | | | | |
| Surlyn | — | — | — | — | — | 12.5 |
| 8150 | | | | | | |
| RABALON | 7 | 8 | 3 | 3 | — | — |
| T3221C | | | | | | |
| Titanium | 4 | 4 | 4 | 4 | 4 | 4 |
| dioxide | | | | | | |
| JF-90 | 0.2 | 0.2 | 0.2 | 0.2 | 0.2 | 0.2 |
| Hc (ShoreD) | 57 | 59 | 61 | 63 | 65 | 67 |

TABLE 4
Results of Evaluation

| | Comp. | Comp. | | | |
|---|---|---|---|---|---|
| | Ex. 1 | Ex. 2 | Ex. 1 | Ex. 2 | Ex. 3 |
| Core | | | | | |
| Composition | D | H | C | F | D |
| Diameter (mm) | 39.8 | 40.2 | 40.0 | 39.4 | 39.0 |
| Dc (mm) | 3.20 | 2.40 | 3.40 | 2.80 | 3.20 |
| Ho (Shore C) | 67 | 70 | 65 | 68 | 67 |
| Hs (Shore C) | 83 | 89 | 82 | 85 | 82 |
| Hs − Ho | 16 | 19 | 17 | 17 | 15 |
| FC₂ (Hz) | 2011 | 2336 | 1950 | 2165 | 2015 |
| Cover | | | | | |
| Composition | b | d | c | b | a |
| Tc (mm) | 1.45 | 1.25 | 1.35 | 1.65 | 1.85 |
| Hc (Shore D) | 59 | 63 | 61 | 59 | 57 |
| Golf ball | | | | | |
| Db (mm) | 2.76 | 1.92 | 2.88 | 2.36 | 2.76 |
| FB₂ (Hz) | 2402 | 2723 | 2375 | 2603 | 2471 |
| FB₂ − FC₂ (Hz) | 391 | 387 | 426 | 438 | 456 |
| FB₂ + FC₂ (Hz) | 4413 | 5059 | 4325 | 4768 | 4486 |
| Performance | | | | | |
| AP spin rate | 4346 | 4382 | 4273 | 4400 | 4378 |
| (rpm) | | | | | |
| Putter | 3.1 | 2.6 | 1.9 | 1.7 | 1.4 |
| evaluation (m) | | | | | |
| Feel at | A | B | A | A | A |
| impact | | | | | |

TABLE 5
Results of Evaluation

| | Ex. 4 | Ex. 5 | Ex. 6 | Ex. 7 | Ex. 8 |
|---|---|---|---|---|---|
| Core | | | | | |
| Composition | G | B | E | C | E |
| Diameter (mm) | 39.6 | 39.4 | 40.0 | 39.0 | 39.2 |
| Dc (mm) | 2.60 | 3.60 | 3.00 | 3.40 | 3.00 |
| Ho (Shore C) | 69 | 65 | 67 | 65 | 67 |
| Hs (Shore C) | 87 | 80 | 85 | 80 | 84 |
| Hs − Ho | 18 | 15 | 18 | 15 | 17 |
| FC₂ (Hz) | 2251 | 1860 | 2088 | 1930 | 2100 |
| Cover | | | | | |
| Composition | c | b | d | c | d |
| Tc (mm) | 1.55 | 1.65 | 1.35 | 1.85 | 1.75 |
| Hc (Shore D) | 61 | 59 | 63 | 61 | 63 |
| Golf ball | | | | | |
| Db (mm) | 2.12 | 3.08 | 2.44 | 2.78 | 2.36 |
| FB₂ (Hz) | 2708 | 2334 | 2566 | 2552 | 2706 |
| FB₂ − FC₂ (Hz) | 457 | 474 | 478 | 622 | 606 |
| FB₂ + FC₂ (Hz) | 4959 | 4194 | 4654 | 4482 | 4806 |
| Performance | | | | | |
| AP spin rate | 4387 | 4278 | 4287 | 4255 | 4273 |
| (rpm) | | | | | |
| Putter | 1.1 | 1.8 | 0.8 | −0.2 | −0.1 |
| evaluation (m) | | | | | |
| Feel at | A | B | A | A | A |
| impact | | | | | |

TABLE 6
Results of Evaluation

| | Ex. 9 | Ex. 10 | Ex. 11 | Ex. 12 | Ex. 13 |
|---|---|---|---|---|---|
| Core | | | | | |
| Composition | F | H | B | F | A |
| Diameter (mm) | 39.0 | 39.6 | 38.6 | 39.0 | 39.2 |
| Dc (mm) | 2.80 | 2.40 | 3.60 | 2.80 | 3.80 |
| Ho (Shore C) | 68 | 70 | 65 | 68 | 64 |
| Hs (Shore C) | 83 | 88 | 78 | 84 | 78 |
| Hs − Ho | 15 | 18 | 13 | 16 | 14 |
| FC₂ (Hz) | 2181 | 2341 | 1853 | 2171 | 1774 |
| Cover | | | | | |
| Composition | c | e | c | e | e |
| Tc (mm) | 1.85 | 1.55 | 2.05 | 1.85 | 1.75 |
| Hc (Shore D) | 61 | 65 | 61 | 65 | 65 |
| Golf ball | | | | | |
| Db (mm) | 2.24 | 1.78 | 2.92 | 2.08 | 3.00 |
| FB₂ (Hz) | 2736 | 2889 | 2555 | 2876 | 2509 |
| FB₂ − FC₂ (Hz) | 555 | 548 | 702 | 705 | 735 |
| FB₂ + FC₂ (Hz) | 4917 | 5230 | 4408 | 5047 | 4283 |
| Performance | | | | | |
| AP spin rate | 4346 | 4324 | 4217 | 4253 | 4200 |
| (rpm) | | | | | |
| Putter | 0.2 | 1.6 | −1.0 | −1.7 | −1.3 |
| evaluation (m) | | | | | |
| Feel at | A | D | A | B | A |
| impact | | | | | |

TABLE 7
Results of Evaluation

| | | | | Comp. | Comp. |
|---|---|---|---|---|---|
| | Ex. 14 | Ex. 15 | Ex. 16 | Ex. 3 | Ex. 4 |
| Core | | | | | |
| Composition | E | C | G | B | F |
| Diameter (mm) | 38.6 | 38.6 | 38.6 | 38.4 | 38.8 |
| Dc (mm) | 3.00 | 3.40 | 2.60 | 3.60 | 2.80 |
| Ho (Shore C) | 67 | 65 | 69 | 65 | 68 |
| Hs (Shore C) | 82 | 79 | 85 | 78 | 83 |
| Hs − Ho | 15 | 14 | 16 | 13 | 15 |
| FC₂ (Hz) | 2079 | 1924 | 2239 | 1838 | 2165 |
| Cover | | | | | |
| Composition | d | d | e | d | f |
| Tc (mm) | 2.05 | 2.05 | 2.05 | 2.15 | 1.95 |
| Hc (Shore D) | 63 | 63 | 65 | 63 | 67 |
| Golf ball | | | | | |
| Db (mm) | 2.30 | 2.66 | 1.86 | 2.82 | 1.98 |
| FB₂ (Hz) | 2815 | 2674 | 2995 | 2639 | 2969 |
| FB₂ − FC₂ (Hz) | 736 | 750 | 756 | 801 | 804 |
| FB₂ + FC₂ (Hz) | 4894 | 4598 | 5234 | 4477 | 5134 |
| Performance | | | | | |
| AP spin rate | 4262 | 4201 | 4276 | 4167 | 4183 |
| (rpm) | | | | | |
| Putter | −1.1 | −1.5 | −1.9 | −1.8 | −2.0 |
| evaluation (m) | | | | | |
| Feel at | A | A | D | A | C |
| impact | | | | | |

TABLE 8
Results of Evaluation

| | Ex. 17 | Ex. 18 |
|---|---|---|
| Core | | |
| Composition | A | B |
| Diameter (mm) | 39.2 | 39.4 |
| Dc (mm) | 3.80 | 3.60 |
| Ho (Shore C) | 70 | 70 |
| Hs (Shore C) | 88 | 88 |
| Hs − Ho | 18 | 18 |
| FC₂ (Hz) | 1779 | 1858 |
| Cover | | |
| Composition | b | c |
| Tc (mm) | 1.75 | 1.65 |
| Hc (Shore D) | 59 | 61 |
| Golf ball | | |
| Db (mm) | 3.24 | 3.00 |
| FB₂ (Hz) | 2329 | 2409 |
| FB₂ − FC₂ (Hz) | 550 | 551 |
| FB₂ + FC₂ (Hz) | 4108 | 4267 |
| Performance | | |
| AP spin rate | 4244 | 4232 |
| (rpm) | | |
| Putter | 0.9 | 0.4 |
| evaluation (m) | | |
| Feel at | B | A |
| impact | | |

As shown in Tables 4 to 8, the golf ball of each Example has favorable feel at impact upon putting. Furthermore, in the golf ball of each Example, the absolute value of the value in putter evaluation is small. This means that the golf ball is a ball with which it is easy for a beginner to adjust a sense of distance. Moreover, the spin rate of the golf ball of each Example upon an approach shot is not considerably reduced. From the results of evaluation, advantages of the present invention are clear.

The golf ball according to the present invention is suitable for, for example, playing golf on golf courses and practicing at driving ranges. The above descriptions are merely illustrative examples, and various modifications can be made without departing from the principles of the present invention.

What is claimed is:

1. A golf ball comprising a core and a cover positioned outside the core, wherein
when a secondary natural frequency of the golf ball is FB₂ and a secondary natural frequency of the core is FC₂, a difference (FB₂−FC₂) is greater than 420 Hz and not greater than 760 Hz.

2. The golf ball according to claim 1, wherein a sum (FB₂+FC₂) of the FB₂ and the FC₂ is not greater than 5200 Hz.

3. The golf ball according to claim 1, wherein the FC₂ is not less than 1700 Hz and not greater than 2400 Hz.

4. The golf ball according to claim 1, wherein the FB₂ is not less than 2250 Hz and not greater than 3050 Hz.

5. The golf ball according to claim 1, wherein the core has an amount of compressive deformation Dc of not less than 2.30 mm and not greater than 3.90 mm.

6. The golf ball according to claim 1, wherein the golf ball has an amount of compressive deformation Db of not less than 1.80 mm and not greater than 3.30 mm.

7. The golf ball according to claim 1, wherein the cover has a thickness Tc of not less than 1.00 mm and not greater than 2.30 mm.

8. The golf ball according to claim 1, wherein the cover has a Shore D hardness Hc of not less than 54 and not greater than 67.
